(19) United States
(12) Patent Application Publication
(10) Pub. No.: US 2023/0220756 A1
(43) Pub. Date: Jul. 13, 2023

(54) SYSTEM FOR STORING AND TRANSPORTING CRUDE OIL

(71) Applicant: Exotex, Inc., Houston, TX (US)

(72) Inventors: Michael J. Parrella, Katy, TX (US); Nevil R. Ede, Westport, CT (US)

(21) Appl. No.: 17/954,737

(22) Filed: Sep. 28, 2022

Related U.S. Application Data
(60) Provisional application No. 63/249,439, filed on Sep. 28, 2021.

(51) Int. Cl. E21B 43/24; E21B 43/40; E21B 43/16

(52) U.S. Cl. CPC E21B 43/24; E21B 43/40; E21B 43/168

(57) ABSTRACT

A system and method for enhanced oil transport and storage are provided. Comprehensive energy recovery and generation systems are provided which supply a heated gas by product, such as carbon dioxide, which to heat oil stored in a storage tank or oil transported in a pipeline, which reduces the viscosity of the oil, thereby increasing the efficiency of the pipeline and the ability to store and transport the oil without sludge accumulations.

### CROSS-REFERENCE TO RELATED APPLICATIONS

The present application claims the benefit of U.S. Provisional Pat. Application 63/249,439 filed Sep. 28, 2021, which is hereby incorporated by reference in its entirety.

### FIELD OF THE APPLICATION

The present application relates to a comprehensive energy system for enhanced oil storage and an enhanced energy system for oil transport.

### BACKGROUND OF THE DISCLOSURE

Currently, oil is stored in storage tanks and in pools. However, these storage systems result in large build-ups of highly viscous sludge, making it more difficult to transport the stored oil. To pump oil through a pipeline the oil needs to have a low viscosity. As heavy crude oil travels through a pipe over distance, the crude oil cools and increases in viscosity, thereby decreasing pumping performance. To reduce viscosity companies are heating the pipes by burning refined fossil fuel, mixing the heavy crude with lighter crude, or adding dilutants to the heavy crude.

### SUMMARY OF THE DISCLOSURE

The present application provides a solution to the aforementioned problems by providing heat in both the oil tanks and the currently existing sludge pools to convert the sludge or heavy crude back into flowing oil and to continually heat the oil so that the sludge does not build up or accumulate during storage or transport.

Benefits of the enhanced oil storage system of the application include: eliminating sludge, eliminating methane emissions, generating low cost electricity, and lowering viscosity of oil using thermal energy and carbon dioxide miscibility.

The present application also relates to a system for enhanced oil transport. The present application uses strategically placed comprehensive energy systems to heat the pipeline and reduce the viscosity of the oil, thereby increasing the efficiency of the pipeline and providing electricity for the pumping stations and the market. The “comprehensive energy systems” described herein may include any of the systems and/or components of the systems described in one or more of U.S. Pat. Nos. 10,267,128 (issued Apr. 23, 2019) and 10,443,364 (issued Oct. 15, 2019) both filed Apr. 7, 2017 and U.S. Pat. Application Nos. 15/517,616 and 15/517,572 filed Apr. 7, 2017, which are hereby incorporated by reference in their entirety.

The objectives of the enhanced oil transport design include: lowering oil viscosity using thermal energy, lowering oil viscosity using carbon dioxide miscibility, and transporting more oil per day.

In accordance with a first aspect of the present application, a method is provided for heating a hydrocarbon, such as oil, while it is being stored or transported. The method comprises providing a vessel containing a hydrocarbon; providing to the vessel a heated gas generated as a byproduct of a device that is used in a hydrocarbon recovery or energy production system configured to extract the recovered hydrocarbon from an underground reservoir and injecting the heated gas into the vessel to reduce viscosity of the hydrocarbon contained in the vessel.

The method according to the first aspect of the present application may include one or more of the following features, alone or in combinations. The hydrocarbon of the method may be a crude oil. The vessel can be a pipeline transporting the crude oil or other hydrocarbon, or a storage tank or container storing the crude oil or other hydrocarbon. The heated gas may be heated carbon dioxide generated by a device used in an oil recovery system. The heated carbon dioxide generated by the oil recovery system may include one or more of: exhaust from a boiler configured to heat a fluid used in the oil recovery system; exhaust from a turbine or a generator configured to generate electric energy used in the oil recovery system; exhaust from a heat exchanger or mixer configured to provide heat to a gas or a liquid used in the oil recovery system; or a pressurized or a compressed gas used by the turbine configured to generate electric energy used in the oil recovery system. Providing the heated gas to the vessel may include providing the heated gas from the device of the hydrocarbon recovery or energy production system along a pipeline to the vessel, and where pipeline to the vessel may include a plurality of vents disposed in the vessel, through which the heated gas is injected into the vessel. The vessel is a storage tank configured to store a crude oil, and the plurality of vents are disposed in a base of the storage tank and are configured to inject the heated gas into the bas of the storage tank to increase the viscosity and fluidity of sludge in the storage tank. The method may further include one or both of providing the hydrocarbon to the vessel from the hydrocarbon recovery or energy production system; and transporting the hydrocarbon out of the vessel to a further location. The method may also include mixing the heated gas injected into the vessel with a mixing device disposed in the vessel.

In accordance with a second aspect of the present application, a system is provided for heating a hydrocarbon, such as oil, while it is being stored or transported. The system comprises a vessel containing a hydrocarbon; a source of a heated gas, the heated gas being generated as a byproduct of a device that is used in a hydrocarbon recovery or energy production system configured to extract the recovered hydrocarbon from an underground reservoir; and an injection device configured to inject the heated gas into the vessel to reduce viscosity of the hydrocarbon contained in the vessel.

The system according to the first aspect of the present application may include one or more of the following features, alone or in combinations. The hydrocarbon of the system can be a crude oil. The vessel is a pipeline transporting the crude oil. The vessel is a storage tank storing the hydrocarbon. The heated gas is heated carbon dioxide generated by a device used in an oil recovery system. The device may include one or more of a boiler configured to heat a fluid used in the oil recovery system and providing a heated exhaust as the heated gas; turbine or a generator configured to generate electric energy used in the oil recovery system and providing a heated exhaust as the heated gas, and or providing a portion of a pressurized or a compressed gas used by the turbine as an input as the heated gas, or a heat exchanger or mixer configured to provide heat to a gas or a liquid used in the oil recovery system and providing a heated exhaust as the heated gas. A source of the heated gas can be a pipeline to the vessel from device that is used in the hydrocarbon recovery or energy production system, and an injection device can be a plurality of vents connected to the pipeline and disposed in the vessel, through which the heated gas is injected into the vessel. The vessel can be a storage tank configured to store a crude oil, and the plurality of vents are disposed in a base of the storage tank and are configured to inject the heated gas into the bas of the storage tank to increase the viscosity and fluidity of sludge in the storage tank. The system may include: an input pipe configured to provide the hydrocarbon to the vessel from the hydrocarbon recovery or energy production system; and an output pipe configured to transport the hydrocarbon out of the vessel to a further location. The system may include mixing the heated gas injected into the vessel with a mixing device disposed in the vessel.

### BRIEF DESCRIPTION OF THE DRAWINGS

FIG. 1 shows an embodiment of an energy system;

FIG. 2 shows another embodiment of an energy system and how it interfaces and supports a comprehensive enhanced oil recovery system;

FIG. 3 shows yet another embodiment of an energy system using liquid to heat the heat delivery wells instead of using an electrical resistant heater;

FIG. 4 shows yet another embodiment of an energy system;

FIG. 5 illustrates a diagram of an energy system for enhanced oil storage in accordance with the present application;

FIG. 6 illustrates a diagram of an enhanced energy system for oil transport in accordance with the present application;

FIG. 7 illustrates a diagram of an enhanced oil transport design, including several heating and pumping stations, in accordance with an embodiment of the present application; and

FIG. 8 illustrates a diagram of an enhanced oil transport design for power generation, in accordance with an embodiment of the present application.

### DETAILED DESCRIPTION OF THE DRAWINGS

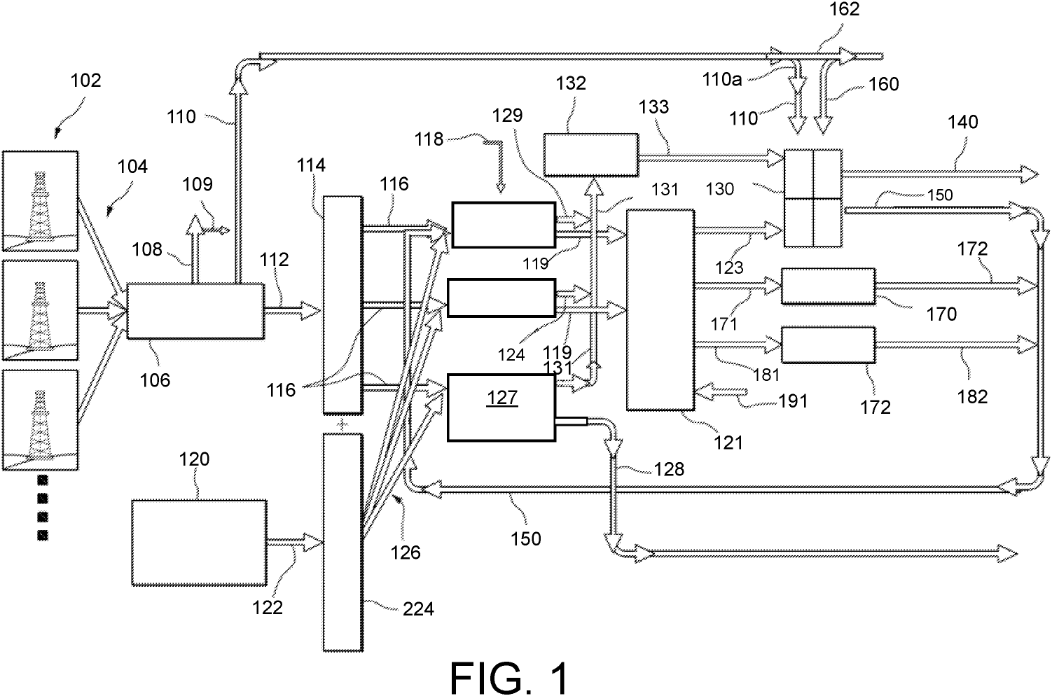

The oil storage and transport system of the present application will be described with reference to FIGS. 1-8.

In accordance with methods and system shown in FIGS. 1-4 and described herein, a comprehensive energy system is provided in which a portion of crude oil or natural gas extracted from an underground reservoir is burned for providing thermal energy. The thermal energy can be transferred to brine separated from the extracted oil, gas, or both, for providing heated brine and/or the thermal energy is converted to mechanical work. The underground reservoir can be heated with the heated brine by injection into the underground reservoir, and/or the underground reservoir is heated with a resistive cable energized by electricity generated by converting the mechanical work to electric energy.

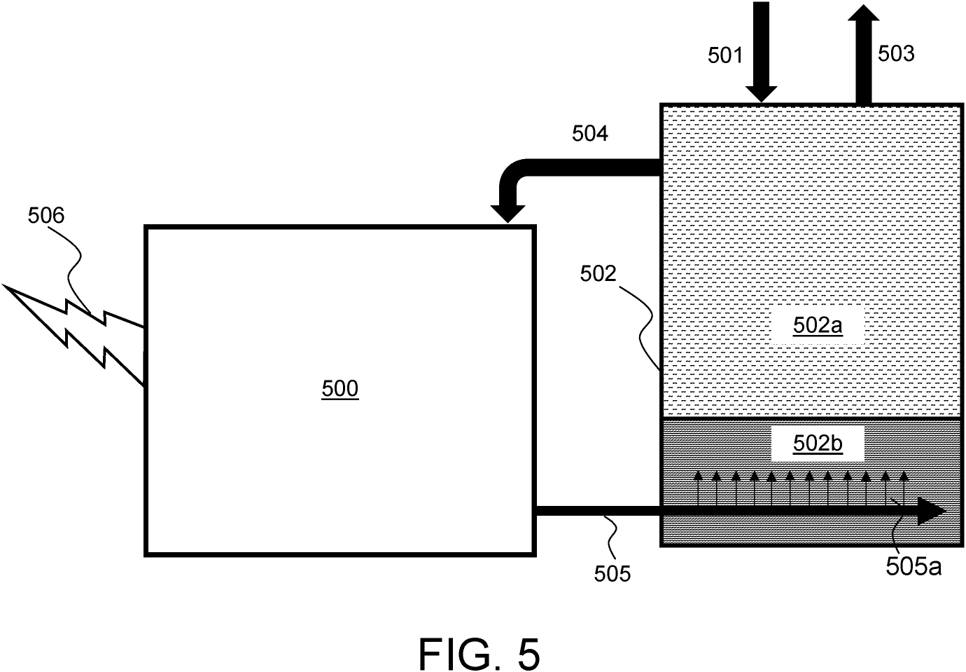

In accordance with the systems of the present application, and shown in FIGS. 5-8 and described below, at least a portion of the thermal energy generated within the comprehensive energy system is transferred out of the system and is used in the heating of an oil storage tank and/or an oil pipeline. Electrical energy generated by the comprehensive energy system is also utilized to provide electricity to components associated with the oil storage and transport.

In embodiments of a comprehensive energy system, a “Green Boiler” may be provided to burn natural gas, crude oil, or both, produced from a reservoir. The boiler may be used to heat a flow of water that circulates in a closed loop out of a heat exchanger in a cooled condition and return a flow of heated water into the heat exchanger in order to transfer heat from the heated water to the brine pumped from a production well and injected back into the reservoir after gaining heat and flowing out of the heat exchanger. As such, the “Green Boiler” is a closed loop system that uses the resources of an oil and gas reservoir to enhance the extraction of oil and gas. The system eliminates any flaring gas and eliminates any harmful emissions of any pollutants into the atmosphere. The byproducts may thus be used in the enhancement process. The heat exchanger may be any type that will transfer heat efficiently from the heated water to the brine such as a counter-flow heat exchanger where the fluids enter the exchanger from opposite ends.

FIG. 1 shows a system and method in which one or more oil wells 102 are pumped to produce a fluid mixture 104 that may include crude oil, natural gas, and brine. The pumped fluid is provided to a separator 106 that represents a pressure vessel that separates the different well fluids into their constituent components of oil, gas and water/brine and that provides separate flows of crude oil 108, brine 110, and natural gas 112. Separators work on the principle that the three components have different densities, which allows them to stratify when moving slowly with gas on top, water on the bottom and oil in the middle. Solids settle in the bottom of the separator. If there is more than one well used and the volume of recovered hydrocarbons is large, a plurality of heat sources may be employed in the system, as in FIG. 1. In such a case, the natural gas may be provided from an outlet of the separator to an inlet of a manifold 114 and split by the manifold into a plurality of natural gas stream outlets provided in piping connected to the plurality of heat sources, in this case, one or more “green boilers” 118. Other types of heat sources such as furnaces may be used as well. It should be realized that some 109 of the crude oil 108 separated by the separator 106 may be used to fuel the heat source either alone or in combination with natural gas. There are boilers that can burn both types of fuel. If in some cases the hydrocarbon recovery volume is low and additional fuel is needed, e.g., crude oil and/or diesel 120, it may be supplied 122 via another manifold 124 to the plurality of heat sources via separate fuel feed pipelines 126. In any event, according to the teachings hereof, the system of FIG. 1 is able to carry out a method of burning crude oil or natural gas extracted from an underground reservoir, or burning both crude oil and natural gas extracted from an underground reservoir, for providing thermal energy.

The natural gas 116 supplied by the manifold 114 may also be supplied to one or more gas, crude oil, or diesel fueled heat engines, such as a gas turbine generator 127 that provides electricity 128. The electricity output from the generator 127 may be connected to an electric resistant cable that is used to produce heat for heating a thermally assisted oil well. The electricity may be used for other purposes as well.

The separated brine 110 from the separator 106 may be provided to a heat exchanger/mixer 130 to be heated. Although shown as a combined heat exchanger/mixer 130, it should be realized the heat exchanger and mixer could be separate. The thermal energy provided by the boilers 118 may be transferred to a fluid such as water circulating in a closed loop through the boilers and the heat exchanger. Heated water is shown being provided on one or more pipelines 119 from outlets of the boilers 118 to at least one inlet of a hot water manifold 121. An outlet of the hot water manifold provides hot water on a line 123 to an inlet of a heat exchanger part of the heat exchanger/mixer 130 or to a separate heat exchanger.

Hot exhaust gases from the one or more heat engines such as exhaust 129 from the plurality of boilers 118 and/or exhaust gases 131 from a gas turbine of the turbine generator 127 are provided to an exhaust scrubber 132. Scrubbed exhaust gases 133, containing carbon dioxide and nitrogen for example, are then provided on a line to the mixer part of the heat exchanger/mixer 130 or to a separate mixer. The mixer performs a mixing of the scrubber exhaust gas 133 from the scrubber 132 (fed by at least one of a heating vessel, e.g., boiler(s) 118 and a heat engine e.g. a turbine of turbine generator 127) with the separated brine at least before, during, or after the transfer of thermal energy to the separated brine, wherein hot brine on the line 140 mixed with the exhaust gas 133 is injected into the underground reservoir via one or more injection wells. A mixer may have a series of fixed, geometric elements enclosed within a housing. The fluids to be mixed are fed at one end and the internal elements impart flow division to promote radial mixing while flowing toward the other end. Simultaneous heating can be done if the mixer is inside the heat exchanger.

The heat exchanger is thus for transferring the thermal energy produced in the boilers 118 to the separated brine 110, for providing heated brine on the line 140, or for converting the thermal energy to mechanical work for instance by a turbine part of the turbine generator 127, or (as in FIG. 1) for both transferring the thermal energy to the separated brine as shown in the heat exchanger/mixer 130 and converting the thermal energy to mechanical work as shown in the turbine part of the turbine generator 127.

The system of FIG. 1 then continues the process by heating the underground reservoir with the heated brine on the line 140 by injecting it into the underground reservoir. Or the system continues the process by heating the underground reservoir with a resistive cable energized by electricity 128 generated by converting mechanical work to electric energy. Or the system continues the process by heating the underground reservoir with both the heated brine and the energized resistive cable.

Cooled circulating water on a line 150 that is shown circulating out of an outlet of the heat exchanger/mixer 130 is returned to the boilers 118 for re-heating and for again being fed into the hot water manifold 121 on pipelines 119 for heating more brine produced on an on-going basis by the oil wells 102. Geothermal heat 191 may be supplied to the hot water manifold 121. It is noted that hot water from the hot water manifold 121 may be further provided on a line 171 to provide heat for a thermally assisted oil well 170, or on a line 181 to other applications 180 requiring heat. The cooled water from these applications can be fed into the cooled circulating water on a line 150 by way of separate lines 172 or 182. It should be mentioned that if viscosity reducing additives are used for instance as shown on a line 160 for mixture in a mixer (not shown) with the extracted brine 110, there will need to be an additive separator (also not shown) as signified by the brine being sent on a line 162 to such an additive separator before it is returned on a line 110a to the heat exchanger/mixer 130.

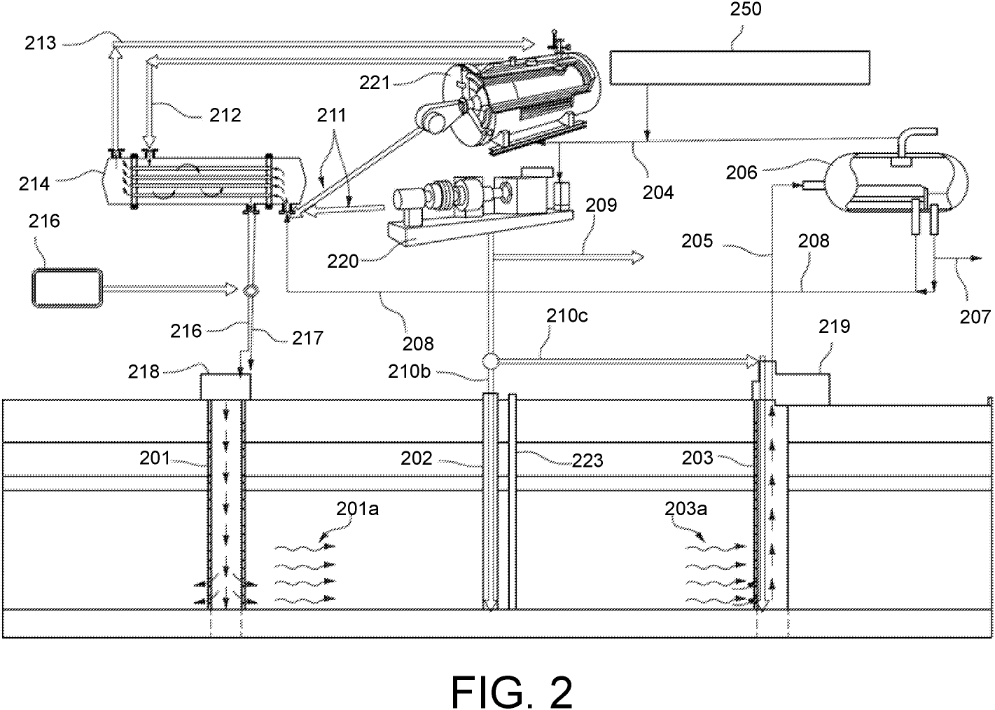

Another exemplary “Green Boiler” System is shown in detail in FIG. 2. Though shown vertically, all wells depicted are horizontal. It should be realized that the wells do not need to be horizontal. For the case where horizontal wells are used, the heat delivery wells may be at right angles relative to the injector and the producer wells or may be implemented in a parallel or angular formation. The system works as follows:

One or more production wells 203 deliver oil, gases and brine (water) on a line 205 (which may contain other elements) to at least one separator 206. The at least one separator 206 separates the oil and provides separated oil 207, provides separated gas on a gas line 204, and provides separated brine 208. The separated brine 208 may include optional additives and/or optional oil. The separated brine 208 with or without the optional additives and/or crude oil is sent to an inlet of at least one heat exchanger/mixer 214. If additives have been used, they are separated from the brine. The oil 207 (less any oil used for fluid injection and any oil that may be used for thermal generation) is sent to a pipeline or a storage tank as recovered crude oil. The gas 204 and/or any oil used for thermal generation is sent to one or more boilers 221 for generation of thermal energy and may also be sent to one or more heat engines connected to an electric generator, such as one or more turbine generators 220 for generation of electricity 209. A further gas or crude oil source 222 may provide gas and/or crude oil 204 into the line. The turbines of the one or more turbine generators 220 may be gas turbines. A gas turbine derives its power from burning fuel such as the gas 204 or crude oil in a combustion chamber and using the fast flowing combustion gases to drive a turbine in a manner similar to the way high pressure steam drives a steam turbine. The difference is that the gas turbine has a second turbine acting as an air compressor mounted on the same shaft. The air turbine (compressor) draws in air, compresses it and feeds it at high pressure into the combustion chamber to increase the intensity of the burning flame. The pressure ratio between the air inlet and the exhaust outlet is maximized to maximize air flow through the turbine. High pressure hot gases are sent into the gas turbine to spin the turbine shaft at a high speed connected via a reduction gear to the generator shaft. In the alternative, the one or more turbine generators 220 may include one or more steam turbines. In that case, the one or more boilers 221 may include one or more steam boilers. Or, exhaust gases from a gas turbine may be supplied to a heat exchanger that produces steam fed to a steam turbine connected to another electric generator (electricity co-generation).

Exhaust 211 from the boiler(s) 221 and turbine(s) of the turbine generator 220 (or other heat engine) is also sent e.g., to an inlet of the heat exchanger/mixer 214, which may be the same inlet as used by the separated brine on the line 208.

The hot water 212 from the closed loop boiler 221 and the cooled water on the line 213 from the heat exchanger/mixer 214 are cycled. The hot water 212 from the boiler 221 is provided to another inlet of the heat exchanger/mixer 214. The heat exchanger/mixer 214 uses the heat from the hot water 212 to heat the brine or brine/oil mixture on the line 208 before, during, or after mixing the brine or brine-oil mixture with the exhaust 211. Thus, the heat exchanger/mixer 214 may mix the exhaust into the brine or brine-oil mixture before, during, or after the heat transfer. Once the heat exchange has occurred, the cooled water on the line 213 is sent back from the heat exchanger/mixer 214 to the boiler 221 for re-heating.

The heated brine/oil mixture 217 may be mixed with the heated exhaust 216 and then optionally mixed with additional additives 215 and sent to one or more injection pumps 218.

The injection pumps 218 injects the combined mixture into one or more injection wells 201, and may include one or more oscillating devices that create pressure waves for the enhanced oil extraction system. In other words, any of the methods shown herein may include stimulating the underground reservoir with pressure waves propagated into the underground reservoir by stimulating the heated brine during injection in an injection well 201.

The one or more injection wells 201 inject heated brine and/or oil, hot exhaust gases such as carbon dioxide, nitrogen, and other gases, and optionally additives into the oil and gas reservoir. Electricity 209 for the injection pump or pumps may be provided by the electric generator of the turbine generator 220.

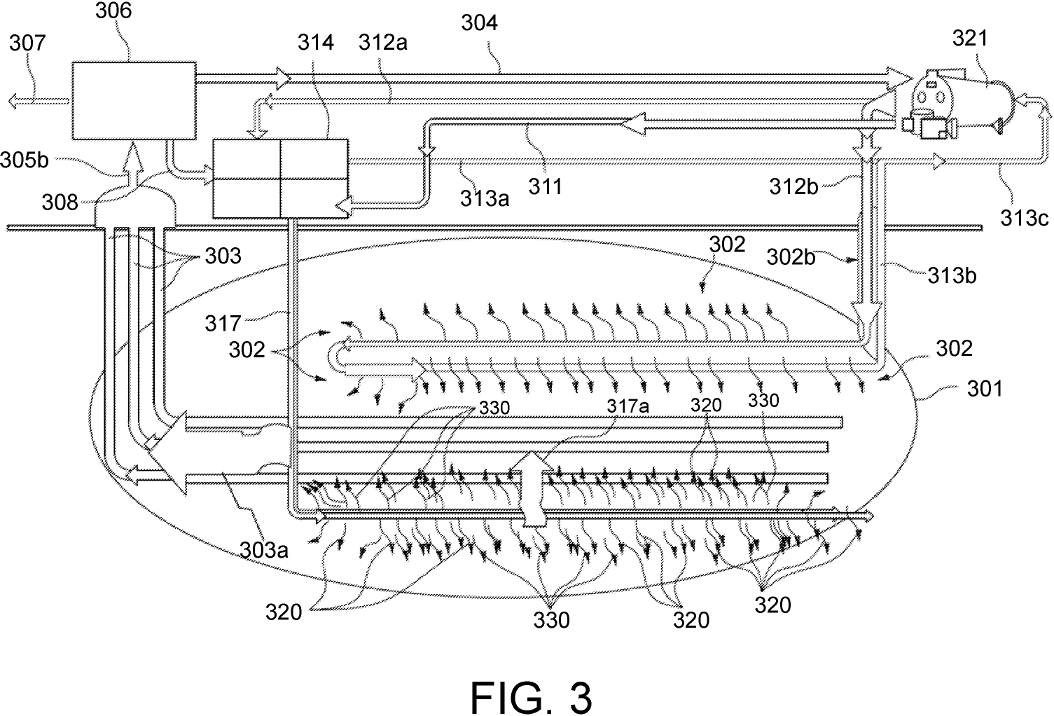

The heat delivery well 202 radiates heat into the reservoir using either electricity generated from the generator of the turbine generator 220 (as shown) and/or water heated by the boiler 221 and circulated in a closed loop (see, e.g., FIG. 3 into and out of a heat delivery well 302b).

One or more producer well pumps include pulsing oscillators 219, and electric heating cables 210 may be powered by the generator of the turbine generator 220. The one or more pulsing oscillators 219 are used to stimulate the underground reservoir with additional pressure waves 203a that are propagated into the underground reservoir. The oil, gas, and brine mixture in a given production well 203 is stimulated during extraction from underground. The additional pressure waves 203a are controlled such that the additional pressure waves 203a are at the same frequency and are synchronized to propagate “in phase” with the pressure waves 201a that are separately propagated into the underground reservoir by stimulation of the heated brine during injection into the well 201. When the “in phase” pressure waves 203a meet the pressure waves 201a in the reservoir between the two wells, they interfere constructively. One or more monitor wells 223 may be employed to provide control information to a control system that controls the operations of the system.

FIG. 3 shows another embodiment where the fluid heated in a boiler 321 is circulated in a closed loop aboveground to and from a heat exchanger/mixer 314, and also belowground in a heat delivery well 302b in an underground oil/gas/brine reservoir 301. It should be realized that the heat delivery well 302b may be fed circulating hot fluid 312b by the boiler 321, by a separate boiler, or by another type of heat source. Wavy arrows 302 are shown emanating from the heat delivery well 302b in the reservoir 301 to signify the transfer of heat to the oil/gas/brine reservoir 301. Oil, gas, and brine produced from one or more production wells 303 is provided on a line 305b to at least separator 306 that provides separated gas on a line 304 to the boiler 321, separated oil on a line 307 for storage, and separated brine on a line 308 to the heat exchanger/mixer 314. As in the case for FIGS. 1-2 as well, the separated gas is not flared, but rather, is used to increase hydrocarbon recovery flow rate. Hot exhaust 311 from the boiler 321 is provided to a mixer part of the heat exchanger/mixer 314 for mixing with the separated brine 308. The hot brine/exhaust mixture is injected into an injection well 317, where hot brine flooding takes place to heat the reservoir, displace the trapped hydrocarbons, and push or move the hydrocarbons toward the one or more production wells 303. Wavy arrows 320, 330 are shown emanating from the injection well 317 into the reservoir 301 to signify the delivery of hot brine/carbon dioxide to heat the oil/gas/brine reservoir 301 and to push and displace gas and oil toward the one or more production wells 303. Hot water 312a from the boiler 321 is provided to the heat exchanger/mixer 314 where it transfers heat to the separated brine 308. The cooled fluid emerging from the heat exchanger 314 on a line 313a may be joined with cooled fluid 313b emerging from the heat delivery well 302b before the joined fluids 313c are together returned to the boiler 321 for re-heating. The re-heated fluid 312a emerges from the boiler 321 for providing to the heat exchanger/mixer 314, and hot fluid 312b circulated to the heat delivery well 302b in a repeating cycle of heating, cooling, and re-heating.

Also shown in FIG. 3, pressure waves 303a may be generated in both the one or more production wells 303 and additional pressure waves 317a in the at least one injection well 317. The underground placement of the production and injection wells with respect to each other may be advantageously set up such that constructive interference is facilitated and controlled with the production and injection waves to stimulate the reservoir simultaneously, continuously and synchronized in-phase to meet in the reservoir and add constructively, thereby increasing the amplitude of the stimulating force imparted to the reservoir. The spatial relationship should be such that at least part of the pressure wave 303a is propagated in a direction toward the injection well 317 and the injection pressure wave 317a is propagated in the opposite direction toward the production well 303 so that the waves meet in a space in between the wells and interfere constructively.

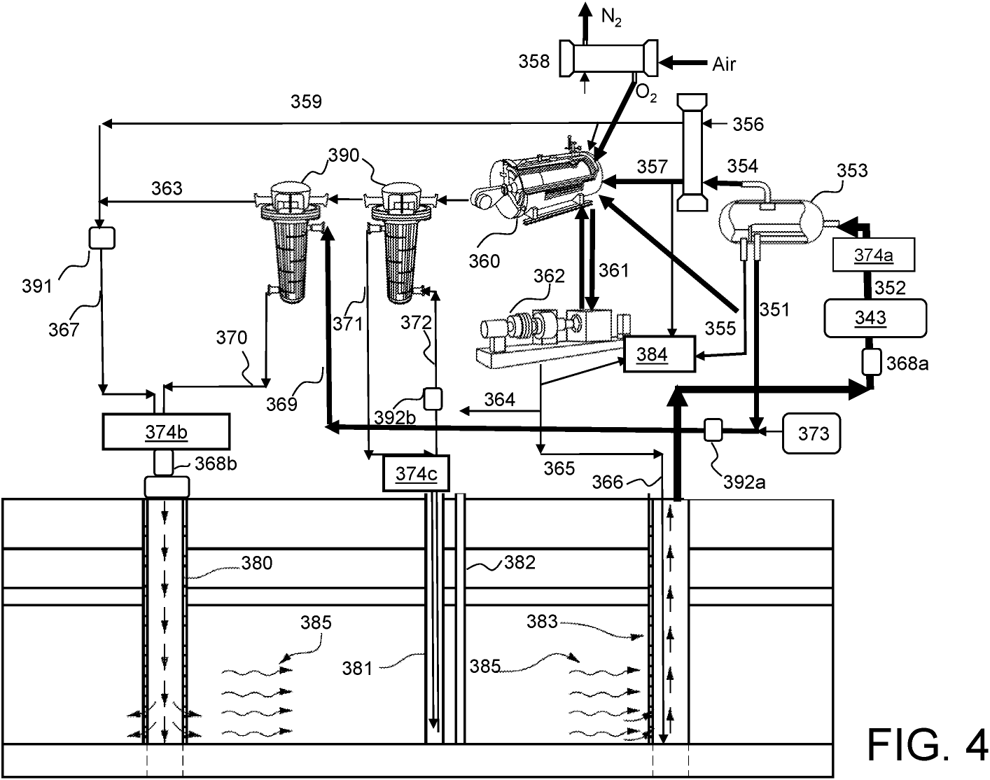

FIG. 4 shows a further embodiment of a “Green Boiler” system comprising injection wells 380, heat delivery wells 381, monitor wells 382 and production wells 383. Although only one of each well is shown in FIG. 4, in a preferred embodiment, five injection wells 380, ten heat delivery wells 381 and five production wells 383 are provided.

The production well 383 pumps oil, gas, brine and/or water 352. The production well 383 is equipped with an oscillator 368a and a jet pump 373, which aid in generating the pressure waves 385 that are used to increase oil recovery in the reservoir. A manifold 374a is also provided between the production well 383 and a separator 353. The separator 353 separates the brine 351, gas 354 and the oil 355.

A boiler and steam turbine or generator 360 is provided with oxygen from an oxygen/nitrogen separator 358, and is provided with the separated gas 354 and/or oil and with methane/carbon dioxide (CH₄/CO₂) 357 from a carbon dioxide/methane separator 356, receiving the separated gas 354. Using these components, the boiler 360 converts water from the steam turbine 362 into steam 361 and generates electricity for operations 364, electricity for sale on the energy market 384, and supplies electricity 365 to an electric heating cable 366 in the production well 383. Carbon dioxide 359 from the oxygen/nitrogen separator 358 can also be added to the inlet flow to the boiler 360 as needed to control flame temperature without adding unwanted N₂ to the exhaust stream.

The exhaust of the boiler and steam turbine or generator 360 is provided to one or more heat exchangers 390 configured to heat water and/or brine. Separated brine 351 is mixed with water and additives 393 and pumped by a pump 392a to a heat exchanger 390, which heats the brine and outputs heated brine 370 to the injection well 380. Carbon dioxide 359, separated by the separator 356, is mixed with hot exhaust 363 from the heat exchanger 390, and compressed by a compressor 391. The compressed and heated carbon dioxide and exhaust gases 367 are supplied to a manifold 374b, and pumped into the injection well 380, which also incorporates an oscillator 368b to aid in creating pulsing pressure waves 385.

The heat delivery well 381 is provided with a manifold 374c. The heat delivery well 381 pumps via a pump 392b cooled water 372 to a heat exchanger 390, which outputs heated water 371. The heated water 371 is provided to the heat delivery well 381 to transfer heat into the well. As the heated water 371 transfers heat to the well, the water cools and the cooled water 372 is provided back to the heat exchanger 390 in a cyclical manner.

In accordance with the present application, byproducts and outputs of a comprehensive energy system or an external energy recovery system, such as the systems described above or variations thereof, are utilized to provide a heat source for heating oil or other hydrocarbons contained in a vessel while the oil or hydrocarbon is being stored or transported. This allows for the utilization of byproducts and outputs, such as exhaust gas, which may not be required for the comprehensive energy system, without these byproducts and outputs of an energy recovery system being released into the environment or atmosphere. This also prevents the unnecessary burning of additional fuel at the point of the energy storage or transport to heat the oil.

FIG. 5 shows an example of use of a comprehensive energy system 500 in the heating of an oil tank 502. As used herein referring to FIGS. 5-8, comprehensive energy system 500 may refer to any of the systems shown in FIGS. 1-4, in whole or in part, or to a system separate from the hydrocarbon storage or transport that is used in separate processes and systems for hydrocarbon or energy recovery, utilization, or processing.

In the system of FIG. 5, heat 505 is supplied the to the oil tank 502, more particularly to the sludge pool 502b, to change the sludge or heavy crude back into flowing oil 502a and to continually heat the oil 502a in the oil tank 502 so that the sludge 502b build up is avoided.

An incoming pipeline 501 may supply oil 502a to the oil tank 502, where it is stored. In alternative systems, the oil tank 502 may be a repository for oil 502a that is coming from a variety of sources, such as delivered oil from a truck or tanker, or the like, or may be storing oil or other hydrocarbons near the source of their recovery, in which the pipeline 501 supplies the oil or hydrocarbon from an underground reservoir. An outgoing oil pipeline 503 is also provided to supply the stored oil 502a for further use.

While in the oil tank 502, if the oil 502a is not heated, sludge 502b can accumulate at the bottom of the oil tank 502. Heat is provided to the bottom of the oil tank 502 in the form of heated carbon dioxide 505 supplied by the energy system 500. The heated carbon dioxide 505 can be provided through a pipe having vents 505a where the heated carbon dioxide 505 where the heated carbon dioxide 505 is supplied to and mixes with the to the sludge 502b. Oil, methane, and/or carbon dioxide 504 can also be supplied from the oil tank 502 to the system 500 for use by the system 500, which further generates electricity 506 while reducing carbon emissions. A mixing device, such as a pump or oscillating pump to circulate the fluid, or a turbine or other rotational stirring mechanism, can be provided to aid in the mixing of the heated carbon dioxide 505 in the oil tank 502. Further, although carbon dioxide is referenced as the heated gas 505 in the exemplary embodiments herein, it is noted that other exhaust gases from the energy recovery systems may alternatively be utilized as the heated gas.

The source of the heated carbon dioxide 505 used to heat the oil tank 502 is from a comprehensive energy system 500, where the heated carbon dioxide 505 is a byproduct of a process or piece of equipment used in the system 500. This may include, for example, heated exhaust gases from one of the devices in the energy system such as a boiler, turbine, generator, heat exchanger, or mixer, such as: hot exhaust gases from the one or more heat engines such as exhaust 129 from the plurality of boilers 118 and/or exhaust gases 131 from a gas turbine of the turbine generator 127 (FIG. 1), scrubbed exhaust gases 133 (FIG. 1), heated and pressurized gas supplied to the turbines of the turbine generators 220 (FIG. 2), exhaust from the boiler 221 (FIG. 2), exhaust from the turbine generators 220 (FIG. 2), exhaust 216 or output from the heat exchanger/mixer 214 (FIG. 2), exhaust 311 from the boiler 321 (FIG. 3), exhaust from heat exchanger/mixer 314 (FIG. 3), carbon dioxide 359 from the separator 358 (FIG. 4), exhaust from the boiler, steam turbine, or generator 360 (FIG. 4), or the compressed and heated gas 367 from the compressor 391 (FIG. 4). In these various implementations of the system in FIG. 5, the heated carbon dioxide 505 that is being provided to the oil tank 502 is a byproduct of another process or system fulfilling a different purpose in the energy recovery or utilization system, where the heated carbon dioxide 505 is being repurposed from that process or system. This prevents the heated carbon dioxide 505 from being put out into the environment or being applied unnecessarily within the particular energy recovery system.

Alternatively, in other embodiments, the heated carbon dioxide 505 may comprise an alternative carbon dioxide source that is heated by a heat source from the comprehensive energy system 500. This could include, for example, heating a gas source using any of the heated water that is utilized or generated from any of the systems shown in FIGS. 1-4 or similar energy recovery systems that can be redirected to this use, heating a gas source using any geothermal heat recovered from any of the systems shown in FIGS. 1-4 or similar energy recovery systems (such as geothermal heat 191 in FIG. 1), or heating a gas source with heated brine, oil and/or gas from any of the systems shown in FIGS. 1-4 or similar energy recovery systems.

Further alternatively, the heated carbon dioxide 505 may comprise an alternative carbon dioxide source that is heated by electricity recovered or generated by the comprehensive energy system 500, such as electricity 128 generated by gas turbine generator 127 (FIG. 1), electricity 209 generated by electric generator 220 (FIG. 2), or electricity generated by the generator 360 (FIG. 4), such electricity being used to power a heating device, such as any of those described herein.

Still further alternatively, embodiments may be provided in which a heating source is applied to the bottom of the oil tank 502 to apply heat to the sludge 502b, such as a heat pipe or boiler containing a heated fluid or an electric cable radiating heat.

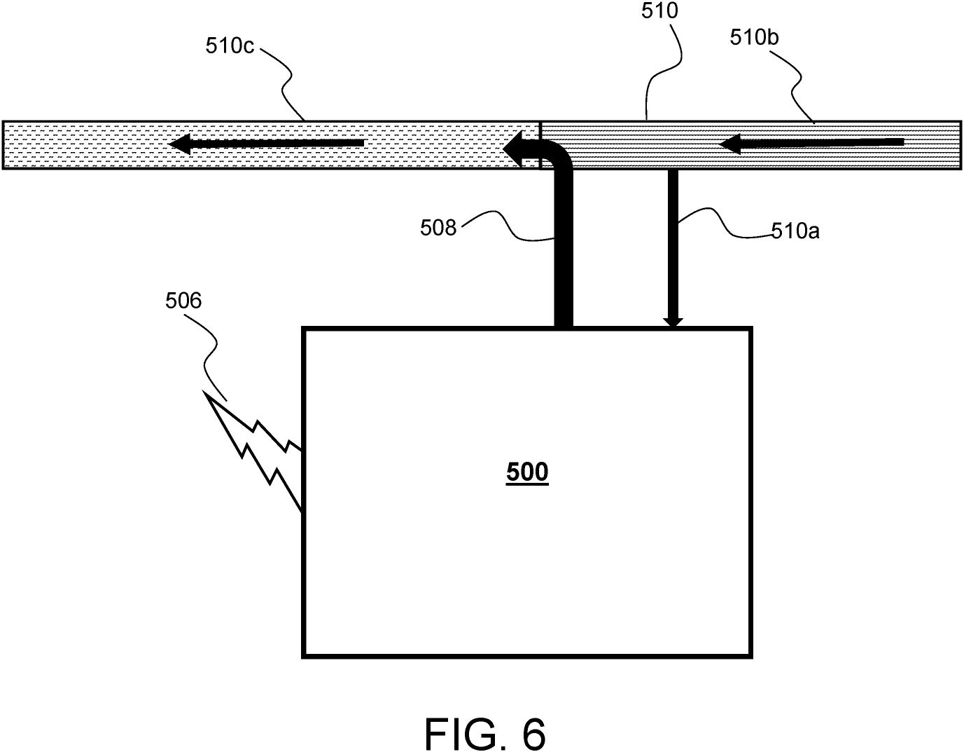

FIG. 6 shows an example of use of a comprehensive energy system 500 in the heating of an oil pipeline 510. Heat is supplied the to the oil pipeline 510, to heat cooler oil 510b in the pipeline 510 so that the transported oil 510c is warmer, thereby avoiding sludge buildup in the pipeline 510, and in the oil tank where the oil may be stored. Heat is provided to the pipeline 510 in the form of heated carbon dioxide 508 supplied by the energy system 500. The heated carbon dioxide 505 can be provided through a pipe having vents where the heated carbon dioxide is supplied to and mixes with the oil in the pipeline 510. Oil 510a can also be supplied from the pipeline 510 to the system 500 for use by the system 500, which further generates electricity 506.

The heated carbon dioxide 505 used in connection with the heating of an oil pipeline 510 may be derived from an energy system 500 in the same manner as described above with respect to FIG. 5.

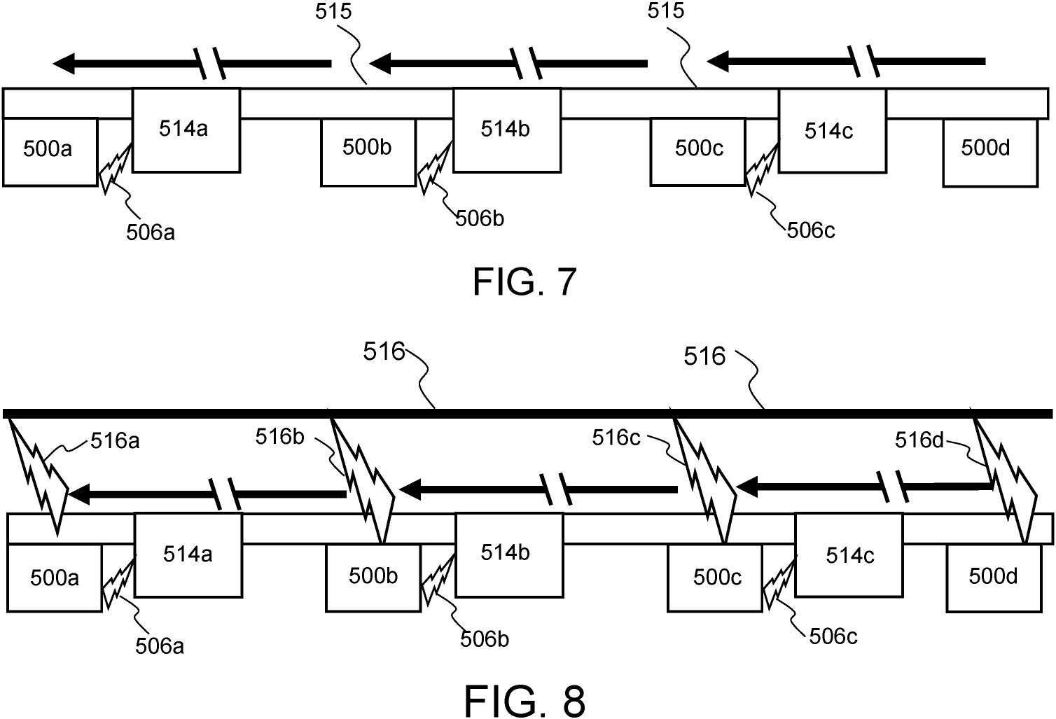

FIG. 7 shows an exemplary system in which heating stations 500a, 500b, 500c, 500d are provided in combination with pumping stations 514a, 514b, 514c positioned along a pipeline 515. The heating stations 500a, 500b, 500c, 500d can be comprehensive energy systems of the nature described herein. The heating stations 500a, 500b, 500c, 500d, supply heat (not shown) to the pumping stations 514a, 514b, 514c to heat the oil that is pumped and/or in the pipeline 515 at the pumping station 514a, 514b, 514c.

The heating stations 500a, 500b, 500c, 500d can supply heat to the pumping stations 514a, 514b, 514c in the same fashion as described above with respect to the providing of heated carbon dioxide 505 to the oil storage tank 502 and the oil pipeline 510 described above with reference to FIGS. 5 and 6. The heating stations 500a, 500b, 500c, 500d may also supply heat to the pipeline 515, consistent with the system shown in FIG. 6 and the pipeline 510 and described above.

The heating stations 500a, 500b, 500c, 500d also supply electricity 506a, 506b, 506c to the pumping stations 514a, 514b, 514c to provide some or all of the electricity required to operate the pumping station 514a, 514b, 514c. The electricity 506a, 506b, 506c can be electricity recovered or generated by the comprehensive energy system 500, such as electricity 128 generated by gas turbine generator 127 (FIG. 1), electricity 209 generated by electric generator 220 (FIG. 2), or electricity generated by the generator 360 (FIG. 4). The pumped and transported oil viscosity is lowered by the thermal energy and carbon dioxide miscibility, which allows for the transport of more oil over a given time period.

FIG. 8 shows a variation of the system shown in FIG. 7, in which the heating stations 500a, 500b, 500c, 500d also supply additional electricity 516a, 516b, 516c, 516d to an electricity transmission line 516 for power generation. The design shown in FIG. 8 uses pipeline right-of-way for electrical transmission, generates low cost electricity using crude oil as fuel, creates no emissions and uses electricity for pump stations.

The heating stations 500a, 500b, 500c, 500d in the design shown in FIGS. 7 and 8 can be positioned every “N” number of miles depending on nature of the environment. The oil is heated along the pipeline, as it travels from the source to the destination.

The heating stations 500a, 500b, 500c, 500d can supply heat to the pumping stations 514a, 514b, 514c in the same fashion as described above with respect to the providing of heated carbon dioxide 505 to the oil storage tank 502 and the oil pipeline 510 described above with reference to FIGS. 5 and 6. The heating stations 500a, 500b, 500c, 500d may also supply heat to the pipeline 515, consistent with the system shown in FIG. 6 and the pipeline 510 and described above.

The heating stations 500a, 500b, 500c, 500d also supply electricity 506a, 506b, 506c to the pumping stations 514a, 514b, 514c to provide some or all of the electricity required to operate the pumping station 514a, 514b, 514c. The electricity 506a, 506b, 506c can be electricity recovered or generated by the comprehensive energy system 500, such as electricity 128 generated by gas turbine generator 127 (FIG. 1), electricity 209 generated by electric generator 220 (FIG. 2), or electricity generated by the generator 360 (FIG. 4). The pumped and transported oil viscosity is lowered by the thermal energy and carbon dioxide miscibility, which allows for the transport of more oil over a given time period.

The heating stations 500a, 500b, 500c, 500d still further may supply electricity 516a, 516b, 516c, 516d to electricity transmission line 516 for power generation. The electricity 516a, 516b, 516c, 516d can be electricity recovered or generated by the comprehensive energy system 500, such as electricity 128 generated by gas turbine generator 127 (FIG. 1), electricity 209 generated by electric generator 220 (FIG. 2), or electricity generated by the generator 360 (FIG. 4). The pumped and transported oil viscosity is lowered by the thermal energy and carbon dioxide miscibility, which allows for the transport of more oil over a given time period.

It should be understood that, unless stated otherwise herein, any of the features, characteristics, alternatives or modifications described regarding a particular embodiment herein may also be applied, used, or incorporated with any other embodiment described herein. Also, the drawing herein is not drawn to scale. Although the invention has been described and illustrated with respect to exemplary embodiments thereof, the foregoing and various other additions and omissions may be made therein and thereto without departing from the spirit and scope of the present invention.

What is claimed:

1. A method comprising:
providing a vessel containing a hydrocarbon;
providing to the vessel a heated gas generated as a byproduct of a device that is used in a hydrocarbon recovery or energy production system configured to extract the recovered hydrocarbon from an underground reservoir; and
injecting the heated gas into the vessel to reduce viscosity of the hydrocarbon contained in the vessel.

2. The method according to claim 1, wherein the hydrocarbon is a crude oil.

3. The method according to claim 2, wherein the vessel is a pipeline transporting the crude oil.

4. The method according to claim 2, wherein the vessel is a storage tank storing the crude oil.

5. The method according to claim 2, wherein the heated gas is heated carbon dioxide generated by a device used in an oil recovery system.

6. The method according to claim 5, wherein the heated carbon dioxide generated by the oil recovery system comprises one or more of:
exhaust from a boiler configured to heat a fluid used in the oil recovery system;
exhaust from a turbine or a generator configured to generate electric energy used in the oil recovery system;
exhaust from a heat exchanger or mixer configured to provide heat to a gas or a liquid used in the oil recovery system; or
a pressurized or a compressed gas used by the turbine configured to generate electric energy used in the oil recovery system.

7. The method according to claim 1, wherein providing the heated gas to the vessel comprises providing the heated gas from the device of the hydrocarbon recovery or energy production system along a pipeline to the vessel, and
wherein pipeline to the vessel comprises a plurality of vents disposed in the vessel, through which the heated gas is injected into the vessel.

8. The method according to claim 7, wherein the vessel is a storage tank configured to store a crude oil, and the plurality of vents are disposed in a base of the storage tank and are configured to inject the heated gas into the bas of the storage tank to increase the viscosity and fluidity of sludge in the storage tank.

9. The method according to claim 1, further comprising:
providing the hydrocarbon to the vessel from the hydrocarbon recovery or energy production system; and
transporting the hydrocarbon out of the vessel to a further location.

10. The method according to claim 1, further comprising:
mixing the heated gas injected into the vessel with a mixing device disposed in the vessel.

11. A system comprising:
a vessel containing a hydrocarbon;
a source of a heated gas, the heated gas being generated as a byproduct of a device that is used in a hydrocarbon recovery or energy production system configured to extract the recovered hydrocarbon from an underground reservoir; and
an injection device configured to inject the heated gas into the vessel to reduce viscosity of the hydrocarbon contained in the vessel.

12. The system according to claim 11, wherein the hydrocarbon is a crude oil.

13. The system according to claim 12, wherein the vessel is a pipeline transporting the crude oil.

14. The system according to claim 12, wherein the vessel is a storage tank storing the crude oil.

15. The system according to claim 12, wherein the heated gas is heated carbon dioxide generated by a device used in an oil recovery system.

16. The system according to claim 15, further comprising the device used in the oil recovery system, wherein the device comprises one or more of:
a boiler configured to heat a fluid used in the oil recovery system and providing a heated exhaust as the heated gas;
turbine or a generator configured to generate electric energy used in the oil recovery system and providing a heated exhaust as the heated gas, and or providing a portion of a pressurized or a compressed gas used by the turbine as an input as the heated gas; or
a heat exchanger or mixer configured to provide heat to a gas or a liquid used in the oil recovery system and providing a heated exhaust as the heated gas.

17. The system according to claim 11, wherein a source of the heated gas is a pipeline to the vessel from device that is used in a hydrocarbon recovery or energy production system, and
an injection device is a plurality of vents connected to the pipeline and disposed in the vessel, through which the heated gas is injected into the vessel.

18. The system according to claim 17, wherein the vessel is a storage tank configured to store a crude oil, and the plurality of vents are disposed in a base of the storage tank and are configured to inject the heated gas into the bas of the storage tank to increase the viscosity and fluidity of sludge in the storage tank.

19. The system according to claim 11, further comprising:
an input pipe configured to provide the hydrocarbon to the vessel from the hydrocarbon recovery or energy production system; and
an output pipe configured to transport the hydrocarbon out of the vessel to a further location.

20. The system according to claim 11, further comprising:
mixing the heated gas injected into the vessel with a mixing device disposed in the vessel.
